(19) United States
(12) Patent Application Publication
(10) Pub. No.: US 2024/0151610 A1
(43) Pub. Date: May 9, 2024

(54) TIRE MEASUREMENT APPARATUS AND METHOD

(71) Applicant: International Marketing, Inc., Chambersburg, PA (US)

(72) Inventors: Robert D. Fogal, JR., Shippensburg, PA (US); Christopher M. Rudyk, Waynesboro, PA (US); Joel M. Lesher, Waynesboro, PA (US)

(73) Assignee: International Marketing, Inc., Chambersburg, PA (US)

(21) Appl. No.: 18/505,806

(22) Filed: Nov. 9, 2023

Related U.S. Application Data
(60) Provisional application No. 63/423,963, filed on Nov. 9, 2022.

(51) Int. Cl. G01M 17/02; G01B 21/10

(52) U.S. Cl. CPC G01M 17/02; G01B 21/10

(57) ABSTRACT

This disclosure describes apparatuses and methods for measuring and/or comparing measurements of tires. Particular embodiments provide a tire measurement apparatus, comprising: at least one tire contact member configured to engage an outer diameter of a tire along a tread of the tire, at least one of the contact members being movable; and, a tire measurement or size indicator configured to indicate a size or graduation measured by the at least two tire contact members. Another embodiment provides a method of measuring the outer diameter of a tire, the method comprising: providing a tire measurement apparatus; placing the tire measurement apparatus in contact with a tire, where the two or more tire contacting members are arranged along an outer diameter of the tire along a tread of the tire; and, measuring the tire to indicate a measurement or size of the tire, where a measurement or size is generated.

### CROSS-REFERENCE TO RELATED APPLICATIONS

This patent application claims the benefit of, and priority to, U.S. provisional patent application No. 63/423,963, filed Nov. 9, 2022 with the U.S. Patent Office, which is hereby incorporated by reference.

### BACKGROUND

This disclosure relates generally to a tire measurement apparatus. More specifically, this disclosure relates to an apparatus and method for measuring and comparing measurements of tires, such as for fleet vehicles, for example.

The benefits of tire matching, that is, ensuring that substantially same sized tires are mounted on a vehicle may be of value for maintaining good vehicle performance and handling. For example, using differently sized tires may cause the vehicle to pull in a particular direction or cause vibrations, loss of traction, or undesired tire wear. This is especially true when differently sized tires are mounted on the same axle, whether on opposite sides of the vehicle or on the same side of the vehicle, such as when using dual tires (as may be used on pickups, vans, over-the-road tractors (semis) and trailers, or other heavy-duty or commercial vehicles. This tire matching is especially of value when mounting used tires, that is, tires in a worn condition, or retreaded tires. Tire management is often employed by managers of vehicle fleets, whether taxis, rental cars, or over-the-road tractors (semis) and/or trailers. One may simply measure each tire's circumference and compare it to another tire's circumference, but this can be laboursome, inconvenient, and time-consuming. There remains a need for a quick and accurate tire size measurement tool and comparison tool and method that solves these and other problems in the prior art.

### SUMMARY

In particular embodiments, the tire measurement apparatus includes at least three (3) tire contact members, at least one of which is movable, and a tire measurement or size indicator. In certain instances, two of the tire contact members are fixed and operably connected to a housing structure. The housing structure, in certain embodiments, comprises a faceplate and a reinforcing brace. In particular embodiments, the at least one movable tire contact members is operably attached to a movable structure, such as a movable arm, for example, which is movable relative to the housing structure. Methods of using the tire measurement apparatus, in accordance with certain embodiments, are described herein.

In other embodiments, the tire measurement apparatus includes at least one tire contact member or two or more tire contact members arranged along a measurement arm, at least one of the tire contact member(s) in either embodiment being movable, and a mounting base configured to be removably installed, or arranged, along an inner diameter or side of a tire or a tire-wheel assembly, the measurement arm extending from the base. Methods of using the tire measurement apparatus, in accordance with certain embodiments, are described herein.

Further embodiments provide a tire measurement apparatus, comprising: at least one tire contact member configured to engage an outer diameter of a tire along a tread of the tire, at least one of the contact members being movable; and, a tire measurement or size indicator configured to indicate a measurement or size measured by the at least two tire contact members. In certain instances, the at least one contact member is at least three contact members, where the at least three contact members are configurable to provide points of contact with the tire that define an arc. In certain instances, an outer diameter of the tire is determinable by calculation based upon a relative location between the points of contact of the at least three contact members. In particular instances, the calculation is performed using the coordinates for each point of contact associated with each of the at least three contact members, where the diameter is determined by doubling a radius determined using an equation of a circle and solving for a radius of the circle, namely, (x−xc)²+(y−yc)²−r²=0, where (xc, yc) are the coordinates for the center of the circle. In certain instances, for the tire measurement apparatus, each of the at least three contact members are cylindrical members. In certain instances, the tire measurement apparatus further comprises a faceplate, the faceplate being operably connected to the at least three contact members, where a back side of the faceplate is configured to be arranged along a sidewall of the tire with each of the at least three tire contact members being arranged along the tire tread. The tire measurement apparatus may provide a movable arm that is operably attached to the faceplate, the movable arm being pivotable and/or translatable relative to the faceplate. In particular instances, the faceplate further includes the tire measurement or size indicator. The tire measurement apparatus may provide that the movable contact member is arranged along a movable arm. The tire measurement or size indicator may include an electronic display. The tire measurement or size indicator may include a scale and a pointer. The pointer may be operably connected to the movable arm. The scale may be arranged along the faceplate. The faceplate may include one or more arced slots in which one or more portions of the movable arm extend. The movable contact member may be arranged along a movable arm, and where each of the faceplate and/or the movable arm include a handle. In certain instances, for the tire measurement apparatus, at least one of the two or more tire contacting members may be fixed. For the two or more tire contacting members, the movable tire contacting member may be arranged adjacent to a pair of tire contacting members. In certain instances, the at least one tire contact member is arranged along a measurement arm, the at least one tire contact member being movable, the tire measurement apparatus further comprising a mounting base configured to be removably arranged along an inner diameter of the tire or of a tire-wheel assembly, the measurement arm extending from the mounting base.

Further embodiments include a method of measuring the outer diameter of a tire, the method comprising: providing a tire measurement apparatus as described herein; placing the tire measurement apparatus in contact with a tire, where the two or more tire contacting members are arranged along an outer diameter of the tire along a tread of the tire; and, measuring the tire to indicate a measurement or size of the tire, where a measurement or size is generated. In particular instances of such methods, in measuring the tire, the tire size is calculated using the coordinates for each point of contact associated with each of the at least three contact members, where the outer diameter is determined by doubling a radius determined using an equation of a circle and solving for a radius of the circle, namely, (x−xc)²+(y−yc)²−r²=0, where (xc, yc) are the coordinates for the center of the circle.

### BRIEF DESCRIPTION OF THE DRAWINGS

The foregoing and other objects, features, and advantages will be apparent from the following more detailed descriptions of particular embodiments, as illustrated or exemplified in the accompanying drawings wherein like reference numbers, symbols, or the like represent like parts, features, or characteristics of particular embodiments:

FIG. 1 shows a side perspective view of a tire measurement apparatus, in accordance with an exemplary embodiment of the disclosure.

FIGS. 2A-2B show, respectively, a top view and a front view of the tire measurement apparatus of FIG. 1.

FIGS. 3A-3E show various views of a mounting brace of the tire measurement apparatus of FIG. 1.

FIGS. 4A-4D show various views of a faceplate of the tire measurement apparatus of FIG. 1.

FIGS. 5A-5D show various views of a measurement arm of the tire measurement apparatus of FIG. 1.

FIGS. 6A-6D show various views of a measurement stop of the tire measurement apparatus of FIG. 1.

FIGS. 7A-7D show various views of a locating dowel, in accordance with an example of the disclosure.

FIGS. 8A-8D show various views of a measurement indicator of the tire measurement apparatus of FIG. 1.

FIGS. 9A-9C show various views of a tire measurement apparatus installed on a tire, in accordance with another exemplary embodiment of the disclosure.

FIGS. 10A-10D show various views of additional features of the tire measurement apparatus of FIGS. 9A-9C.

FIGS. 11A-11C show various views of a tire measurement apparatus installed on a tire, in accordance with yet another exemplary embodiment of the disclosure.

FIGS. 12A-12D show various views of additional features of the tire measurement apparatus of FIGS. 11A-11C.

FIG. 13 shows the contact members of the tire measuring apparatus shown in FIG. 1, the contact members arranged in contact with the tread of a tire mounted on a wheel, the contact members being arranged around a circumference of the tire tread in accordance with an embodiment of the invention.

FIG. 14 shows a front view of the tire measurement apparatus of FIG. 1, in accordance with an alternative embodiment.

### DETAILED DESCRIPTION OF PARTICULAR EMBODIMENTS

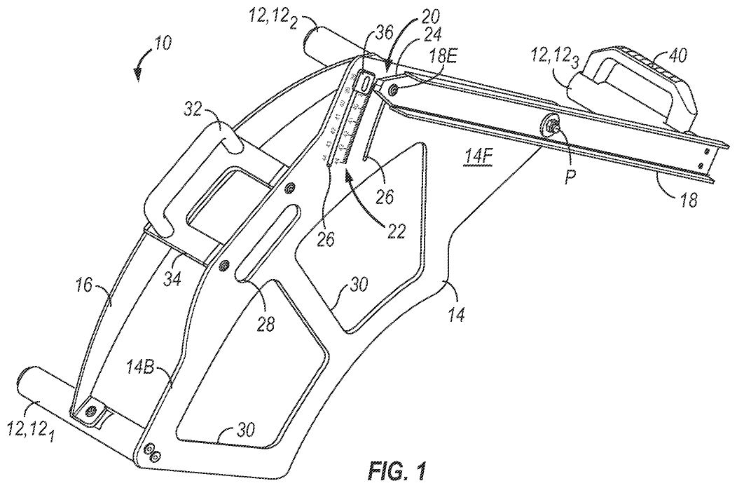

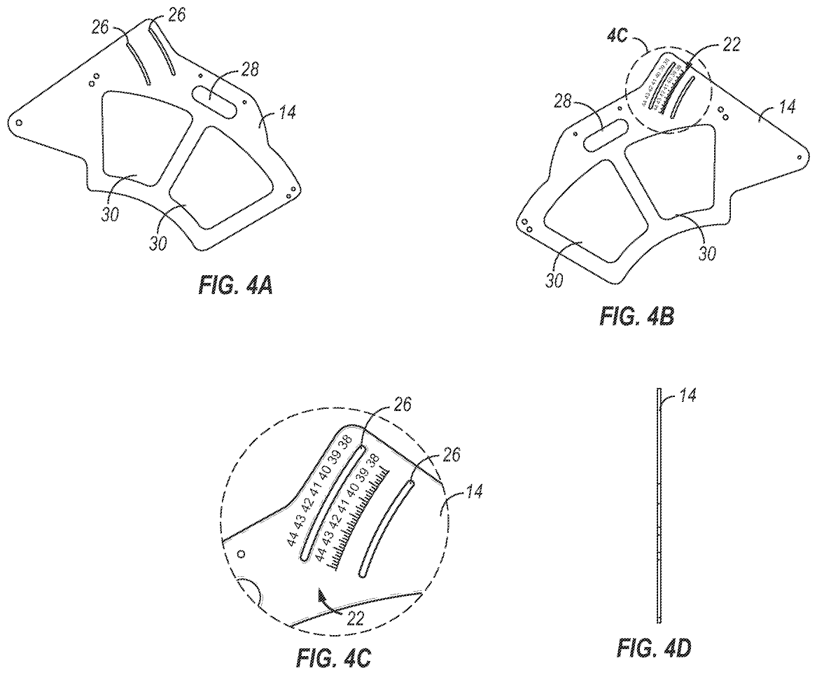

Referring now to FIGS. 1-8D, a tire measurement apparatus 10 in accordance with a particular embodiment of the present disclosure includes three (3) tire contact members 12, a frame comprising a faceplate 14, a reinforcing brace 16, a movable arm 18, and a tire measurement or size indicator 20, which incorporates and utilizes certain features of the faceplate 14 and the movable arm 18. At least one of the tire contact members moves, relative to the other tire contact members, although any quantity (two or more), including all, tire contacting members may move in other embodiments. It is possible to have more than three (3) tire contacting members in other embodiments.

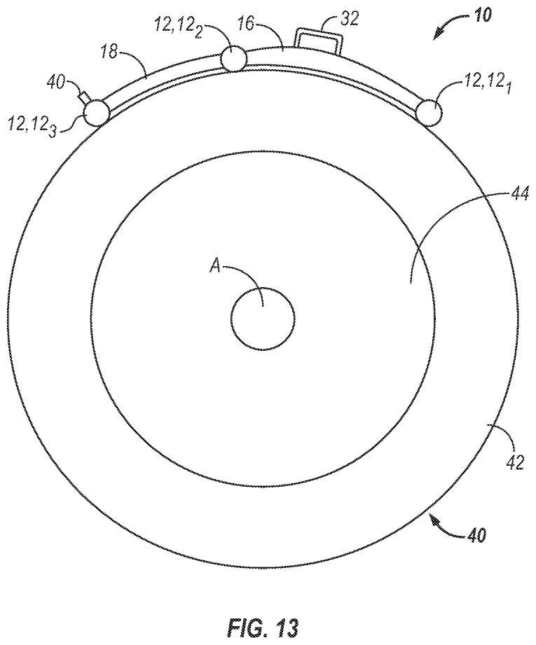

Generally, the tire measurement apparatus 10 operates by placing the three (3) contact members 12 in contact with the annular tread of the tire. Being annular, the tire tread has an outer circumference (or periphery) and can be described as having a crown, which is an area of maximum circumference. Ideally, the three (3) contact members 12 and the points of contact define an arc forming a portion of a circle extending around and defining the outer circumference (or periphery) of the tire along the tire tread (e.g., the tire tread crown). Such an arrangement is shown in FIG. 13, by example, where an embodiment of the tire measurement apparatus 10 is shown arranged along a tire 42 of a tire-wheel assembly 40, where tire 42 is mounted on a wheel 44. By knowing the relative location of the three (3) contact members 12, the tire's diameter is determinable by calculation. In particular, by knowing the fixed distance between each of the contact members, or more precisely between the points of contact, and the angularity between the contact members 12 (that is, the relative location between the contact members 12), the (x,y) coordinates of each point of contact are determinable. The location of the points of contact may be determined by measuring the location of different features associated with each contact member, and by knowing the distance from that measured location to the point of contact for that corresponding contact member. For example, the location of a bolt arranged to extend along a centerline axis of an elongate, cylindrical contact member may be measured, knowing the elongate centerline axis is spaced apart or offset from its point of contact with the tire by ½ the thickness of the elongate, cylindrical tire contact member. It is contemplated that any manner of determination the location of a point of contact for any tire contacting member may be employed, such as measuring other locations or using sensors. Using the coordinates for each point of contact associated with each of the three (3) contact members 12, the radius may be determined using the equation of a circle and solving for radius, namely, (x−x_{c})²+(y−y_{c})²−r²=0, where (x_{c}, y_{c}) are the coordinates for the center of the circle. And by doing so, the tire diameter may be determined, as the diameter is equal to twice (2×) the radius. To obtain the radius using the three (3) points of contact, each corresponding (x, y) coordinate is separately input into the circle equation to obtain three (3) separate quadratic equations. Then subtract the first quadratic equation from the second quadratic equation and separately subtract the first quadratic equation from the third quadratic equation to obtain two (2) separate linear equations. Then, using the two (2) linear equations, solve for the center to obtain values for (x_{c}, y_{c}) and insert the values for the center coordinates into any of the quadratic equations to obtain the radius. Other techniques known to one of ordinary skill for determining a radius or diameter using three points on a circle may be employed. It is contemplated that the coordinates used for the calculation may be of the actual points of contact or may be of another offset or spaced location, which is spaced apparat from the point of contact, such as by a known fixed distance. After determining the size using those offset or spaced coordinates, the actual radius or diameter my adding or removing the distance by which the offset or spaced coordinates are spaced apart from the point of contact in a radial direction of the tire.

Using these techniques, the tire measurement apparatus is able to indicate to a user the size of the tire (that is, the tire diameter or radius) being measured. In lieu of actual tire size, any other scale distinguishing between different relative tire sizes may be employed. For example, a scale of 1 through 10 or A through F, or simply line markings or demarcations may be used.

In an exemplary embodiment shown in FIGS. 1-2B and 4A-4D, faceplate 14 has a front side 14F and a back side 14B. The three (3) tire contact members 12 project outwardly from the back side 14B and form a part of, or are operably connected to, the faceplate 14. The faceplate 14 back side 14B is configured to engage and be arranged along either sidewall of the tire (each sidewall being arranged on axially or widthwise opposing sides of the tire), such that the contact members 12 are arranged along the outer circumference of the tire along the tire tread (also referred to as the tire crown). In the embodiment shown, each contact member is a cylindrical or dowel-shaped member, but may be any desired member or structure capable of engaging the tire tread. For example, a tire contact member may be elongate with a triangular, rectangular, or square cross-section, or may be symmetrical or nonsymmetrical in cross-section. In the exemplary embodiment shown, the faceplate 14 is a generally flat panel or sheet having a front side 14F and a back side 14B, but other suitable variations or structures may be employed whether flat or not.

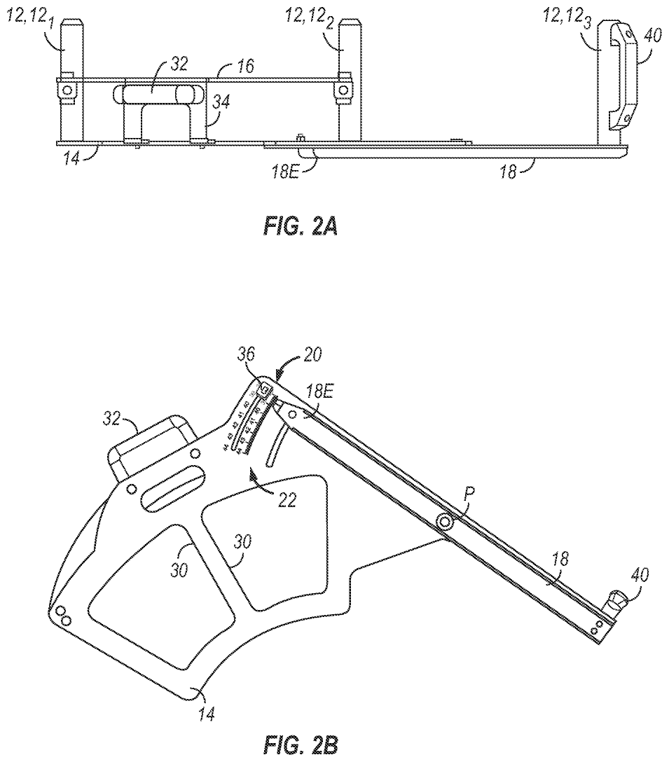

With reference again to the exemplary embodiment shown in FIGS. 1-2B, a movable measurement arm 18 is attached to the faceplate 14 in a movable manner. Movable means pivotable (rotatable) and/or translatable. In the variation shown, the measurement arm is pivotable only about point P. The faceplate may further include a plurality of guide channels for receiving guide members from the measurement arm, and the optional measurement indicator. The faceplate may also include a graduation in close proximity to the plurality of guide channels, where the graduation corresponds to a tire measurement. The measurement may be an actual size of the tire, in radius or diameter, or it may be some other indicator of a size, such as by use of alphabetized or alphanumeric indicia, symbols, or any other desired indicia. The faceplate may also include a plurality of holes to aid mechanical fastening to the mounting bracket and the plurality of locating dowels.

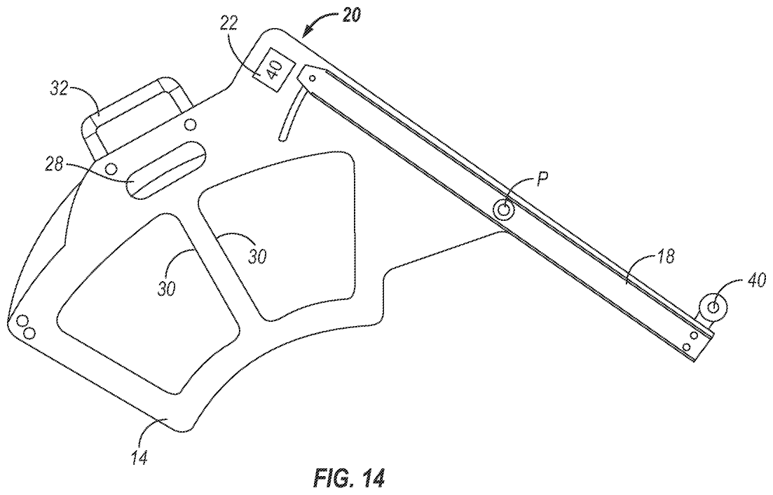

As noted herein, tire measurement apparatus includes a tire measurement or size indicator. In the embodiment shown in FIGS. 1-2B, tire measurement or size indicator 20 includes a scale 22 and a pointer 24. The scale 22 is located on faceplate 14 and contains a range of tire size measurements, pre-calculated according to the techniques described herein and as otherwise known to one of ordinary skill. Scale 22 is operable with a pointer 24 mounted to the movable measurement arm 18, where the pointer 24 points to a tire size on the scale 22 as the movable arm is arranged in a measurement position along the tire. Other variations and embodiments are available and within the scope of this invention. For example, in lieu of actual tire sizes, the scale may include any other desired measurement indicia or markings. By further example, scale 22 could be arranged on the movable measurement arm 18 and the pointer 24 arranged on the faceplate 14. Alternatively, by further example, a digital scale or indicator could also be used. Other apparatus or mechanisms known to one of ordinary skill for identifying the tire measurement or a relative tire size scale may be employed in other embodiments in lieu of scale 22 and pointer 24. For example, a tire measurement or size indicator may be an electronic indicator, such as an analog or digital scale or size indicating device. Any means of indicating a tire measurement or size may be employed, such as use of a corresponding electronic or digital display. For example, the electronic or digital display may be arranged in operational connection with corresponding sensors arranged in and/or on a corresponding tire contact member or with an input device, through which signals or digital information is received, such information including location inputs associated with readings corresponding to the relative location of each tire contact member or its corresponding point of contact along the tire. Such sensors may be any desired sensor, such as a proximity or position sensor or even GPS, for example. Any known sensor for attaining the relative location of a contact member or a point of contact of any tire contact member may be employed. A logic processor may be employed in operational communication with the power source, the display, and any input devise or sensors. The logic processor processes any executable instructions to perform the calculations contemplated in this disclosure to measure or determine the size of any subject tire based upon any sensor readings or positional locations obtained when the tire contact members are properly arranged along a tire as contemplated herein. Any memory device may be employed suitable for its intended purpose of storing instructions for interpreting the positional information and other associated information and/or calculating the measurement or size of a subject tire as contemplated herein, to store related information, and to communicate with the logic processor, the display, and any input device or sensor. Any memory device may be employed, such as any RAM, ROM, or flash memory device, for example. The tire measurement or size indicator, in these embodiments, may be powered by one or more power sources, such as a battery or any other known electric source. By example, in FIG. 14, a tire measurement or size indicator 20 is shown in an alternative embodiment, the indicator comprising an electronic display 22 that provides measurements or sizes, and operates as a digital scale 22. This embodiment also employs a logic processor, memory device, and/or use of any sensors, all arranged in operable communication or operable connection with one another, such as by wire or wireless connection/communication. A power source is also in operable connection therewith.

Optionally, faceplate 14 includes one or more arced slots 26 in which portions of the movable arm 18 extend, such as to further assist in guiding, constraining, and supporting the arm as it moves, and in the embodiment shown in FIGS. 1-2B pivots. The slots are arranged adjacent or near scale 22, but may also be arranged on the opposite side of pivot P or along the other side of arm 18 to aid in guiding, constraining, and/or supporting other portions of the arm 18 during movement. Also, and optionally, faceplate 24 includes a handle 28. In the embodiment shown, the handle 28 is a cutout or hole formed within faceplate 14, but other forms of handles may be employed, such as a protruding handle extending outwardly from the faceplate. Optionally, additional voids 30 are formed within faceplate 24 to reduce the weight of the faceplate.

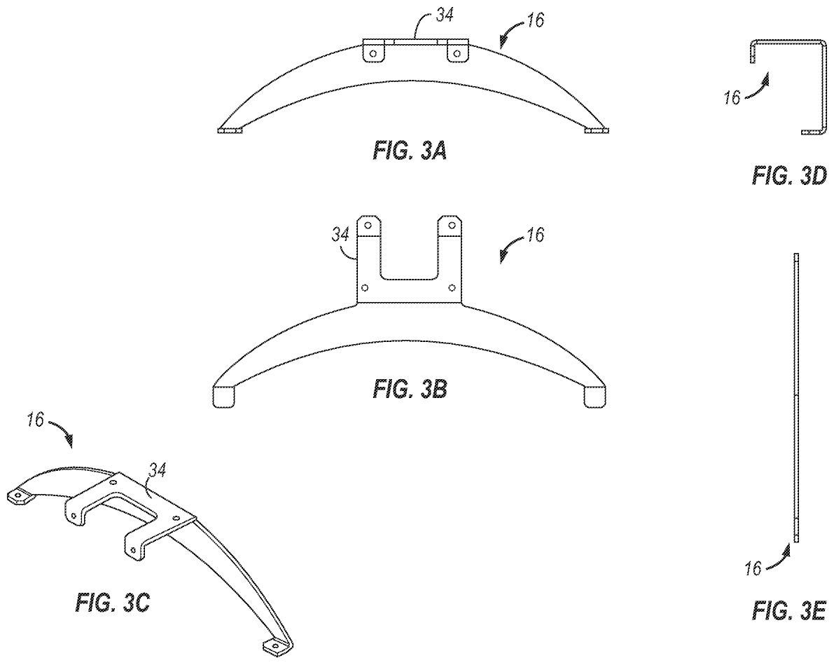

It is contemplated, one or more reinforcing structures, referenced herein as braces, may be optionally employed. With reference to an exemplary embodiment in FIGS. 1-2B, a brace 16 is operably connected to each of the fixed tire contact members 12 (12₁, 12₂) and to faceplate 14. In lieu of a single brace 16, multiple may be employed, such as when employing separate braces for each fixed contact member 12. Brace 16 optionally includes a handle 32 extending from a cross-member 34 of the brace 16. Additional and/or alternative handles may be employed as desired. The single brace 16 is shown alone in FIGS. 3A-3E, where FIG. 3B shows the brace 16 in an intermediate, unbent form prior to final shaping.

It is contemplated that faceplate 14, as well as brace 16 and arm 18 may be formed of any desired and suitable material, such as, for example, metal (steel, aluminum, etc.) or plastic. Contact members 12 may also be formed of any desired, suitable material, such as metal or plastic, for example, and may rotate along its own axis, such as in the case of a cylindrically-shaped contact member 12, for example, and/or the contact member 12 may include rollers or bearings, for example, to facilitate easy movement along the tire.

The tire measurement apparatus is adaptable to measure different tire sizes by having at least one of the contact members movable relative to the other contact members. For example, in the embodiment shown in FIGS. 1-2B, a pair of contact members 12₁, 12₂ are fixed along tire measurement apparatus 10, while the third contact member 12₃ is movable. In the embodiment shown, the pair of contact members 12₁, 12₂ are arranged adjacent to one another, but this may not be true in other variations, where the movable contact member is arranged between the fixed contact members. Movable contact member 12₃ is arranged along movable arm 18. It is contemplated that any movable contact member may be arranged along any movable structure or may move itself in relation relative to fixed contact members.

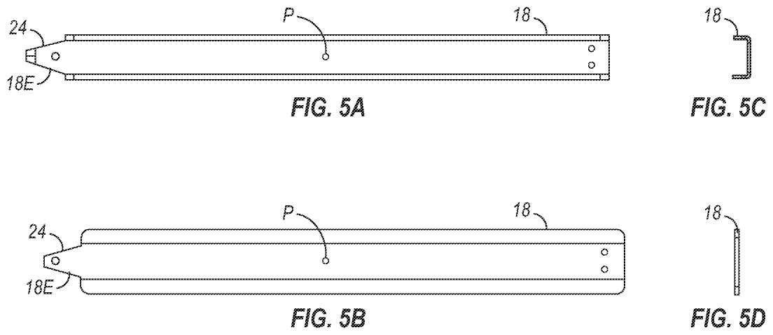

In an exemplary embodiment shown in FIGS. 5A-5D, the movable measurement arm 18 is an elongate member forming a C-channel, although any other suitable structure may be employed as arm 18, whether or not elongate so long as its suitable to move the movable tire contacting member 12. With particular reference to FIG. 5B, arm 18 is shown as a flat member, unbent, prior to being bent to form a C-channel form. A first distal end of arm 18 is optionally pointed or narrowed, such as for the purpose of identifying a measured tire size along the scale 22 on faceplate 14. The first distal end 18E may operate as the pointer 24 itself, or a separate member(s), such as pointer member 34, may be operably attached to arm 18, whether or not at the first distal end 18E, to operate as pointer 24.

Pivot P between arm 18 and faceplate 14 may be achieved using any desired mechanism, such as a fastener (e.g., nut and bolt), rod, bearing, pin, or axle, for example.

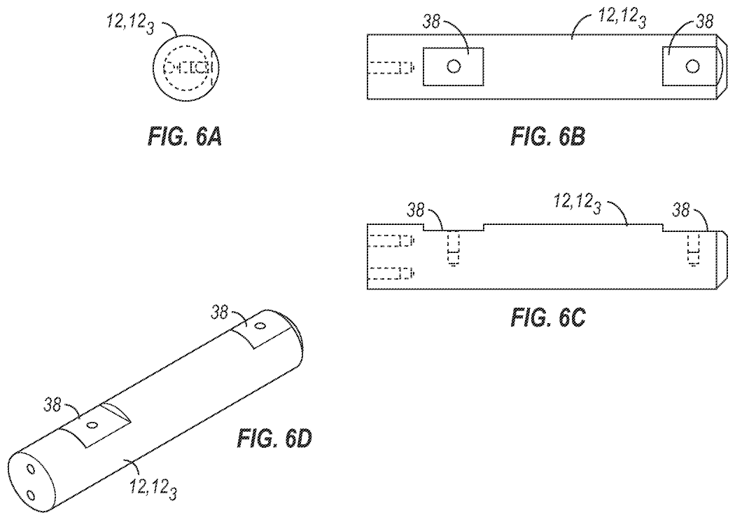

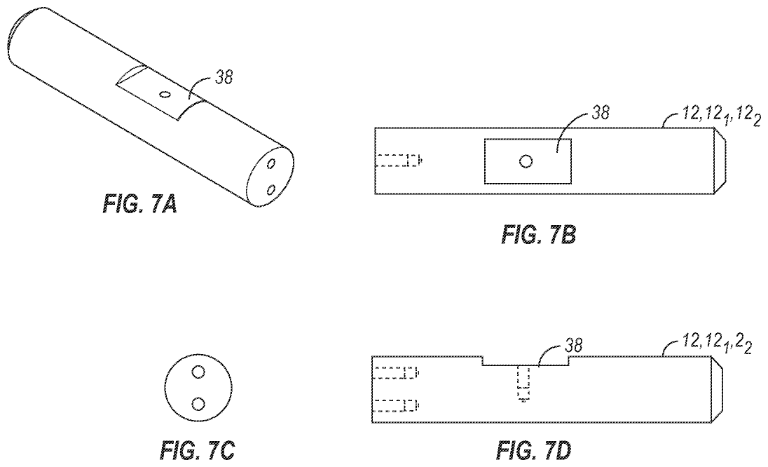

In an exemplary embodiment shown in FIGS. 6A-6D, a movable tire contact member 12 (12₃) is shown in greater detail, while in FIGS. 7A-7D, a fixed tire contact member 12 (12₁, 12₂) is shown in greater detail. Members 12 (12₁, 12₂, 12₃) are shown in a generally cylindrical form. One end of each contact member 12 may be tapped to aid mechanical fastening to the measurement arm 18 or the faceplate 14. Other means, methods, and mechanisms may be employed to connect or arrange contact member 12 along arm 18 or faceplate 14. A contact member 12 may also include a plurality of indents 38 for engaging or receiving attachment tabs from an optional handle 40 or from brace 16 with optional apertures for receiving securing fasteners.

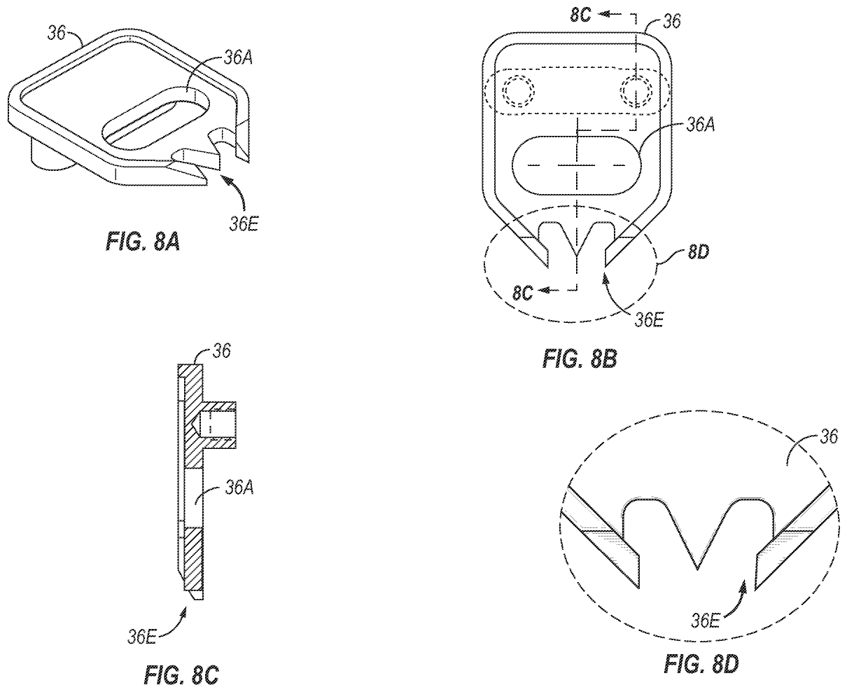

In the exemplary embodiment shown in FIGS. 8A-8D, the pointer member 36 is shown in greater detail. Pointer member 36 operably attaches to the first end 18E of arm 18, and includes a pointed end 36E and an aperture 36A forming a window for viewing aspects of the scale located on the faceplate 14 associated with the tire size measured. This optional pointer member may take other forms and designs in other embodiments. Moreover, multiple pointer members may be employed in other embodiments of the tire measuring apparatus.

The described tire measurement apparatus may be used to determine and compare measurements of tires. To determine a tire measurement the tire measurement apparatus is placed on the tire so that the pair of fixed contact members are engaged with the tire tread along the tire tread circumference while the faceplate is abutted against one of the pair of opposing tire sidewalls. The measurement arm is moved to place the movable tire contact member in engagement with the tire tread along its circumference to arrive at a measurement for the tire with all three (3) contact members in contact with the tire tread and its circumference. This tire measurement may be marked using the measurement indicator and the graduation optionally provided on the faceplate to aid in comparison of tire measurements.

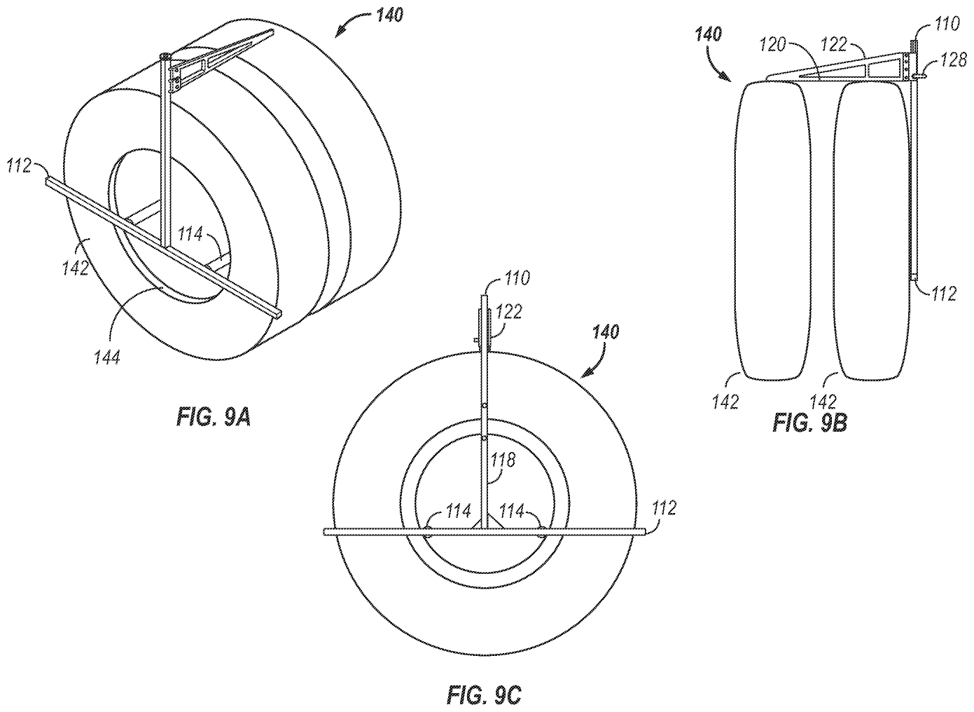

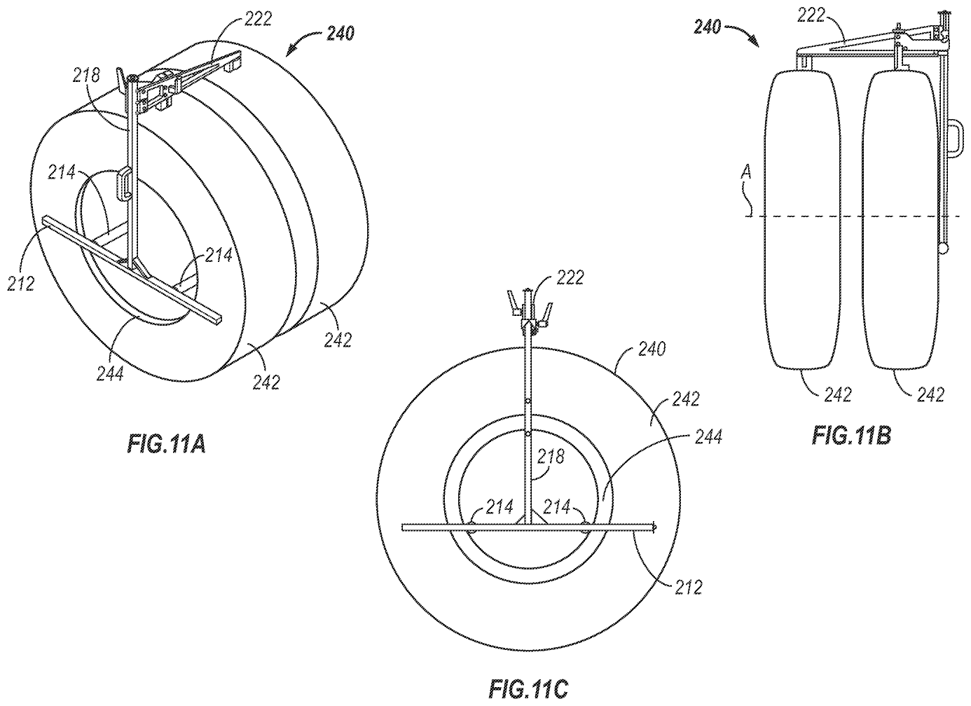

In other embodiments, the tire measurement apparatus includes at least one tire contact member or two or more tire contact members arranged along a measurement arm, at least one of the tire contact member(s) in either embodiment being movable relative to a mounting base, the mounting base configured to be removably installed, or arranged, along an inner diameter or side of a tire or a tire-wheel assembly, the measurement arm extending from the base. The inner diameter of a tire may correspond to the bead area or mounting seating area of the tire, as is shown FIGS. 9C and 11C, for example. The inner diameter of a tire-wheel assembly may be the rim or rim flange, which is the portion of the wheel upon which the tire is mounted along the bead area. An inner diameter may also be or coincide with the rotational axis of the tire-wheel assembly or any annular or circular feature of the wheel.

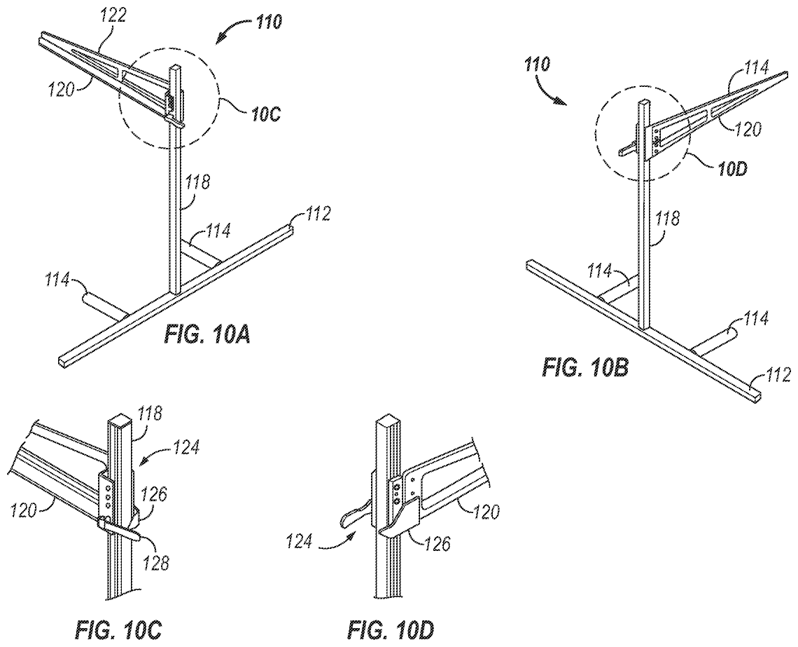

A particular embodiment shown in FIGS. 9A-9C, where a tire measurement apparatus 110 is shown installed along a tire-wheel assembly 140 comprising a tire 142 mounted on a wheel 144, where the tire measurement apparatus is installed or arranged along an inner diameter or side of the tire-wheel assembly, and more specifically along an inner side or diameter of the wheel of the tire-wheel assembly. In FIGS. 10A-10D, the tire measurement apparatus 110 is shown uninstalled. The tire measurement apparatus 110 includes a mounting base 112, which includes a pair of tire-wheel contacting members 114 and a measurement arm 116 extending from the base 112. The measurement arm 116 includes a post 118 extending lengthwise from the base 112 and a tire contacting surface 120 extending in a direction perpendicular from the post 118. The tire contacting surface 120 operably translates in the direction of the post's length, that is, in both opposing directions (e.g., up and down) along the post's length. In the embodiment shown, the tire-wheel contacting members 114 are elongate members, and extend in a direction substantially perpendicular to the post. Nonetheless, the tire-wheel contacting members may be formed differently, and whether or not elongate, so long as they are capable of mounting the tire measurement apparatus 110 along the tire-wheel assembly 140. The tire contacting surface 120 extends linearly in a direction substantially perpendicular to the rotational axis A of the tire-wheel assembly 140. The tire contacting surface 120 is also associated with or operably connected to a structure 122 which slides along the length of the post 118. A tire measurement scale 124 is arranged along the post 118 and an indicator 126 is arranged in association with the structure 122, such that the indicator 126 identifies a measured size of the tire contained in the scale 124 when the surface 120 engages the tread of the tire along its circumference or crown as shown in FIGS. 9A-9C. The indicator is best shown in FIGS. 10C-10D. In alternative embodiments, an electronic indicator may be employed as described elsewhere herein. Likewise, the scale may comprise any graduations and/or desired indicia or markings to indicate a measurement amount or size. An optional lock 128 is further included to lock the movable structure 122 in a desired position along post 118, such as relative to scale 124, for example. Movement and locking of the structure 122 along post 118 may be achieved by any means known to one of ordinary skill. For example, movement may be achieved by mere sliding engagement or by track or rack and pinion, and movement may be achieved manually or automatically by crank or motor. By further example, locking may be achieved by using a pin, a cam lock, a brake, or any other known means. It is also contemplated that a movable measurement marker (not shown) may be included that may remain in a position of a prior tire measurement, so to compare the tire currently being measured to one previously measured, so to obtain a direct comparison between measured tires.

The described tire measurement apparatus may be used to determine and compare measurements of tires. To determine a tire measurement the tire measurement apparatus 110 is mounted on the tire-wheel assembly 140 such that the plurality of tire-wheel contacting members 114 are engaged with the inner side or inner diameter 146 of the tire or wheel, such as is exemplarily shown in FIGS. 9A-9C. The measurement arm 116 is then manipulated such that the tire contacting surface 120 is placed into engagement with the tire tread 148 along its circumference in the crown area. In doing so, the indicator 126 identifies a size of the tire along the scale 124. This process may be repeated for multiple tires and the measurements compared. It is also possible to measure multiple tires as is shown in FIGS. 9A-9C when the tread contacting surface 120 spans multiple tires. In such instances, the tire contacting surface 120 is placed in a position to engage the largest tire and obtain a measurement of the largest tire, which is particularly well suited for comparing tire sizes between dual tire arrangements. The gap between the tire contacting surface 120 and the smaller tire may be measured manually using a ruler or tape, or by using additional measurement features included with the tire measurement apparatus as discussed below in other embodiments. It is also possible to automate all measurements taken in any embodiment discussed or contemplated herein, using electronic or laser measuring devices as substitutes for the indicator-scale combination or, such as with the laser, the laser may operate as the indicator for use with a visible scale in a further embodiment.

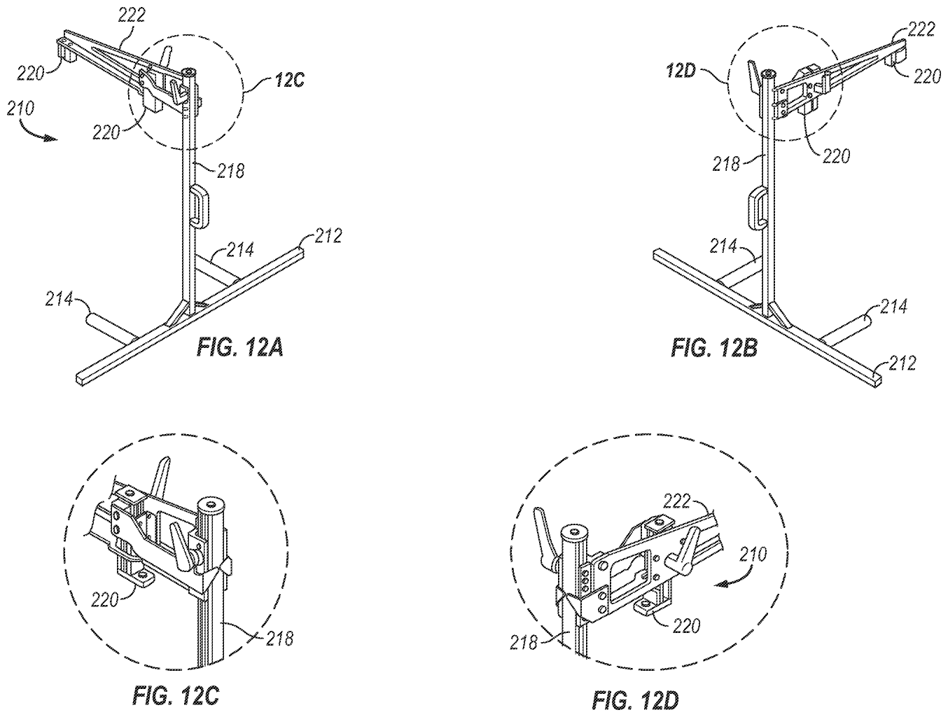

In a further exemplary embodiment shown in FIGS. 11A-11C, a tire measurement apparatus 210 is shown installed on a tire-wheel assembly 240. In FIGS. 12A-12D, the tire measurement apparatus 210 is shown uninstalled. The tire measurement apparatus 220 includes the features of tire measurement apparatus 110 discussed above, except that in lieu of having a single tire contact surface 120 it has multiple tire contact surfaces 220A, 220B for the purpose of measuring multiple tires (such as in the of dual tire arrangements, as shown in the referenced figures). Although two are shown, more than two may be employed to measure any desired quantity of tires. In the embodiment shown, each tire contact surface 220A, 220B is movable relative to structure 222 in a direction towards (and away from) the tire tread, such as in a direction perpendicular to the rotational axis A of the tire-wheel assembly 240. Upon contact, an indicator 218 associated with each tire contact surface 220 is employed to measure the corresponding tire relative to a scale. Itis possible that a surface of the structure 222 operates as an indicator relative to a corresponding scale, such as the bottom surface of structure that operates as the tire contact surface in other embodiments, such as in the embodiments discussed above in association with apparatus 110. It is also possible for only one of the multiple tire contact surfaces 220 to move relative to structure 222, whether any non-movable contact surface 220 extends from structure 222 or forms part of structure 222. It is also possible for any tire contact surface 220 to move transversely along structure 222, such as, for example, in a direction generally parallel to the tire-wheel assembly rotational axis A.

The tire measurement apparatus 220 shown in FIGS. 11A-11C and 12A-12D, is particularly well adapted for measuring and comparing measurements between separate tires in a dual tire arrangement. When used to compare the measurements of dual tires the measurement arm is manipulated until the first contact surface is engaged with the tread of the first tire. The second contact surface is moved until it is in engagement with the tread of a second tire. The difference in measurements between the first and second tires is then determined by the displacement between the first and second measurement indicators.

In any described embodiment, the tire measurement apparatus and its component parts may be made of metal, plastic, or any other suitable rigid or semi-rigid material. While in particular embodiments, the measuring apparatuses discussed and contemplated in this disclosure are directed to tire-wheel assemblies, whether or not pressurized, all apparatuses may be used to measure tires not mounted on wheels in the same manner described. Any combination of features disclosed herein may be employed in any particular embodiment of a tire measuring apparatus.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural forms of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

I/We claim the following:

1. A tire measurement apparatus, comprising:
at least one tire contact member configured to engage an outer diameter of a tire along a tread of the tire, at least one of the contact members being movable; and,
a tire measurement or size indicator configured to indicate a measurement or size measured based upon the at least two tire contact members.

2. The tire measurement apparatus of claim 1, where the at least one contact member is at least three contact members, where the at least three contact members are configurable to provide points of contact with the tire that define an arc.

3. The tire measurement apparatus of claim 2, where an outer diameter of the tire is determinable by calculation based upon a relative location between the points of contact of the at least three contact members.

4. The tire measurement apparatus of claim 3, where the calculation is performed using the coordinates for each point of contact associated with each of the at least three contact members, where the diameter is determined by doubling a radius determined using an equation of a circle and solving for a radius of the circle, namely, (x−x_{c})²+(y−y_{c})²−r²=0, where (x_{c}, y_{c}) are the coordinates for the center of the circle.

5. The tire measurement apparatus of claim 1, where each of the at least three contact members are cylindrical members.

6. The tire measurement apparatus of claim 2 further comprising:
a faceplate, the faceplate being operably connected to the at least three contact members, where a back side of the faceplate is configured to be arranged along a sidewall of the tire with each of the at least three tire contact members being arranged along the tire tread.

7. The tire measurement apparatus of claim 6, where a movable arm is operably attached to the faceplate, the movable arm being pivotable and/or translatable relative to the faceplate.

8. The tire measurement apparatus of claim 7, where the faceplate further includes the tire measurement or size indicator.

9. The tire measurement apparatus of claim 1, where the movable contact member is arranged along a movable arm.

10. The tire measurement apparatus of claim 9, where the tire measurement or size indicator includes an electronic display.

11. The tire measurement apparatus of claim 9, where the tire measurement or size indicator includes a scale and a pointer.

12. The tire measurement apparatus of claim 11, where the pointer is operably connected to the movable arm.

13. The tire measurement apparatus of claim 11, where the scale is arranged along the faceplate.

14. The tire measurement apparatus of claim 9, where the faceplate includes one or more arced slots in which one or more portions of the movable arm extend.

15. The tire measurement apparatus of claim 6, where the movable contact member is arranged along a movable arm, and where each of the faceplate and/or the movable arm include a handle.

16. The tire measurement apparatus of claim 1, where at least one of the two or more tire contacting members is fixed.

17. The tire measurement apparatus of claim 1, where, for the two or more tire contacting members, the movable tire contacting member is arranged adjacent to a pair of tire contacting members.

18. The tire measurement apparatus of claim 1, where the at least one tire contact member is arranged along a measurement arm, the at least one tire contact member being movable, the tire measurement apparatus further comprising a mounting base configured to be removably arranged along an inner diameter of the tire or of a tire-wheel assembly, the measurement arm extending from the mounting base.

19. A method of measuring the outer diameter of a tire, the method comprising:
providing a tire measurement apparatus as provided in claim 1;
placing the tire measurement apparatus in contact with a tire, where the two or more tire contacting members are arranged along an outer diameter of the tire along a tread of the tire; and,
measuring the tire to indicate a measurement or size of the tire, where a measurement or size is generated.

20. The method of claim 19, where in measuring the tire, the tire size is calculated using the coordinates for each point of contact associated with each of the at least three contact members, where the outer diameter is determined by doubling a radius determined using an equation of a circle and solving for a radius of the circle, namely, (x−x_{c})²+(y−y_{c})²−r²=0, where (x_{c}, y_{c}) are the coordinates for the center of the circle.
